(19) United States
(12) Patent Application Publication
(10) Pub. No.: US 2006/0219613 A1
(43) Pub. Date: Oct. 5, 2006

(54) Water purification system and method

(76) Inventors: Richard W. Scheu, Rainier, OR (US); Nathan Jacobson, Rainier, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/097,567

(22) Filed: Apr. 1, 2005

(51) Int. Cl. B01D 35/14

(52) U.S. Cl. 210/108; 210/130; 210/134; 210/192; 210/257.2; 210/258; 210/259; 210/195.2

(57) ABSTRACT

A water purification system is provided that includes a pre-filtration system for pre-filtering water, a first pump, a nano-filtration membrane configured to separate pre-filtered water into nano-filtered water and effluent, a holding tank, and a second pump. The first pump is operable for pumping pre-filtered water through the nano-filtration membrane, and the second pump is operable for pumping nano-filtered water from the holding tank into the plumbing of a building.

### TECHNICAL FIELD

This disclosure relates generally to water purification systems, and more particularly to systems that provide purified water for an entire building or home. The disclosed water purification systems include a pre-filtration system, a first pump, a nano-filtration membrane, a holding tank and a second pump.

### BACKGROUND

Many methods have been developed to treat and purify water. These methods seek to create a safe water supply free from sediment, minerals, harmful chemicals, and microbiological impurities. For example, sediment filters have been developed that remove undissolved, and potentially harmful particulate from water. Activated charcoal filters have been developed that remove chlorine, and some organic and microbiological impurities. Ultraviolet light has been used to sterilize bacteria. Generally, these treatment and purification methods are employed at the point of use, and are not used to purify and store water for an entire building or home.

Various membranes have also been developed that separate impurities from water based on the size of the impurity. For example, micro-filtration membranes are semi-permeable membranes with pore sizes ranging from 0.1-3 microns. Micro-filtration membranes retain large suspended solids, such as particulate matter, while passing small suspended solids and all dissolved materials. Ultra-filtration membranes are semi-permeable membranes with pore sizes ranging from 0.005-0.1 microns. Ultra-filtration membranes retain suspended solids, oils, bacteria, large macromolecules and proteins, while passing most small organic compounds, acids, and alkaline compounds. Nano-filtration membranes are semi-permeable membranes with pore sizes ranging from approximately 0.0005-0.005 microns. Nano-filtration membranes retain all solids, bacteria, macromolecules, organic compounds, and divalent salts, while passing monovalent salts, acid and alkaline compounds. Reverse osmosis (“RO”) membranes are membranes with pore sizes in the range of 0.0005 microns (5 Angstroms). RO membranes retain all solids, bacteria, macromolecules, organic compounds, divalent salts, monovalent salts, acid and alkaline compounds, while passing essentially pure water. Generally, these membranes are employed at the point of use, and are not used to purify and store water for an entire building or home.

Various home systems have also been developed for softening water. Hard water is water that contains high concentrations of divalent cations, such as calcium and magnesium. These minerals leave white deposits, called scale, on water using appliances. They also attach to the water pipes in a home, and eventually restrict the flow of water through the pipes. Most home water softener systems use ion exchange chemistry to replace calcium and magnesium ions with softer sodium ions. However, the softened water produced by ion exchange chemistry has an unpleasant flavor. Further, ion exchange water softeners result in large quantities of chloride salts being washed down the drain, and some municipalities in various states have begun to ban these water softeners because they violate wastewater standards. Some home systems soften water using RO membranes. As discussed above, RO membranes retain divalent slats, monovalent salts, acids and alkaline compounds, while passing essentially pure water. Due to the highly restrictive nature of RO membranes, water treated by RO membranes is stripped of its buffering acids and bases, thereby leaving the product water very acidic. If this water is left untreated, it will gradually destroy metals or materials it comes into contact with. While safe to drink, water treated with RO membranes will eat at the piping in the home unless there is a post-filtration treatment of the water. RO membranes also waste a great deal of water, with a product to waste water ratio of up to approximately 1:1.

There is a need to provide a water purification system which may safely and effectively purify and soften water before it enters the plumbing of a building or home. In particular, there is a need to provide a water purification system for a building that effectively removes harmful contaminants and also softens water without the disadvantages of ion exchange water softeners and RO membranes.

### BRIEF DESCRIPTION OF THE DRAWINGS

FIG. 1 is a diagram of the water purification system according to the present disclosure.

FIG. 2 is a profile view of a water purification system according to the present disclosure.

FIG. 3 is a block diagram of an embodiment of the water purification system according to the present disclosure.

FIG. 4 is a front view of the water purification system of FIG. 3.

FIG. 5 is a block diagram of the water purification system of FIG. 3 in a pre-operation state, or alternatively in Idle mode.

FIG. 6 is a block diagram of the water purification system of FIG. 3 in Water Purification mode.

FIG. 7 is a block diagram of the water purification system of FIG. 3 in Recirculation mode.

FIG. 8 is a block diagram of the water purification system of FIG. 3 in Backwash mode.

FIG. 9 is a block diagram of the water purification system of FIG. 3 in Bypass mode.

FIG. 10 is a block diagram of the water purification system of FIG. 3 in Chemical Cleaning mode.

### DETAILED DESCRIPTION OF THE DEPICTED EMBODIMENTS

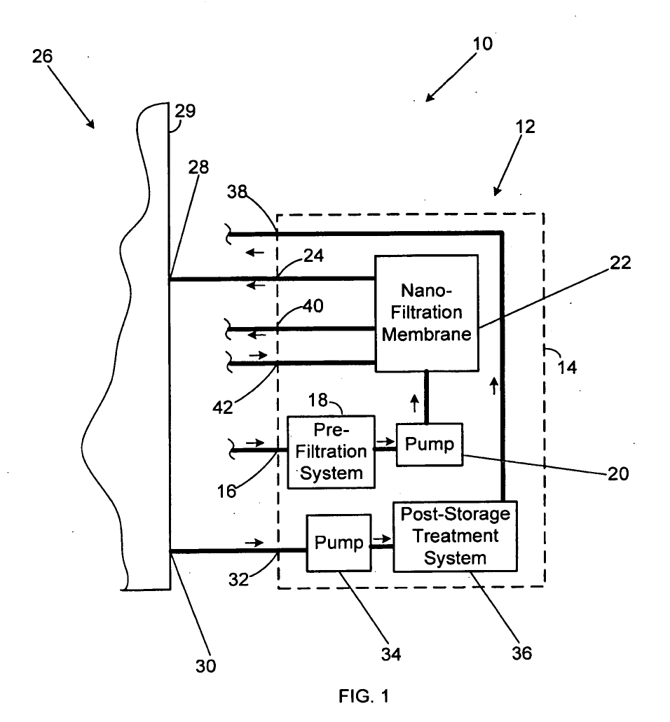

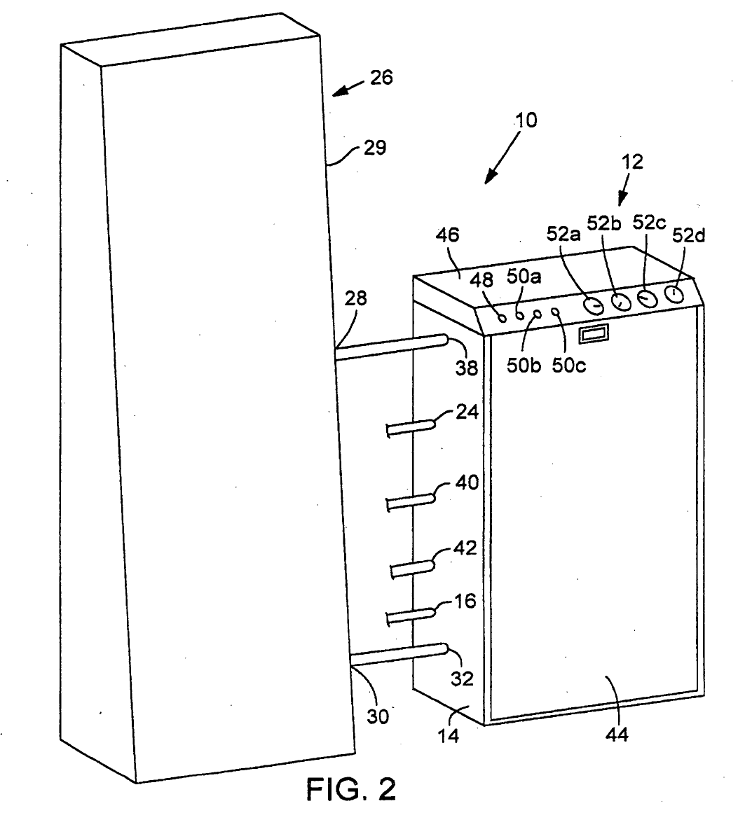

FIGS. 1-2 show water purification system 10, which may be configured to purify some or all of the water entering the plumbing of a building, home or dwelling unit. System 10 may include a water filtration unit 12 and a holding tank 26.

Water filtration unit 12 may include a housing 14, and a plurality of inputs, outputs and internal plumbing components that filter water and direct the flow of liquid through water purification system 10, as indicated by the arrows in FIG. 1. Specifically, the water filtration unit may include inlet from source 16, pre-filtration system 18, first pump 20, nano-filtration membrane 22, outlet to tank 24, inlet from tank 32, second pump 34, post-storage treatment system 36, and outlet to the plumbing of the building 38. The water filtration unit may also include a drain outlet 40 and a cleaning solution inlet 42.

Housing 14 may be a box, cabinet or other structure configured to contain the internal components of water filtration unit 12, and to facilitate transportation, assembly and maintenance of the water filtration unit. As shown in FIG. 2, the housing may include a panel 44 and a control unit 46, which may both be removable to provide for access to the various components of the water filtration unit.

Control unit 46 may function to control, or provide a user with information about, the operation of the water purification system 10. For example, control unit 46 may include circuitry (not shown) that controls pumps, valves, or other plumbing components, in order to operate the water purification system in various modes. Control unit 46 may include a power button 48, for turning the water filtration unit on/off. Control unit 46 may also include LEDs, such as LEDs 50a-c, for displaying information about the purification system. For example, the LEDs may be configured to light up to indicate that the purification system is operating in a particular mode. The LEDs may also light up periodically to indicate when service or maintenance is due to be performed on the purification system. Control unit 46 may include gauges, such as gauges 52a-d, which display diagnostic information about the purification system. The gauges may include water meters for measuring the amount of water passing through various locations within the plumbing of the purification system. The gauges may also include pressure gauges displaying the water pressure at various locations within the plumbing of the purification system.

Inlet 16 may be configured to receive water from a water source (not shown). The water source is most commonly a municipal water main, but may also include a well, a storage tank, a cistern, or any other water source. Water pressure from a municipal water main commonly fluctuates between approximately 40-70 psi.

The water received by inlet 16 may be directed through pre-filtration system 18 for removing sediment, bacteria, and other organic impurities from the water, and for dechlorinating the water. For example, the pre-filtration system may include a sediment filter, such as a filter for removing suspended solids greater than approximately 5 microns in size. The pre-filtration system may include a chlorine removal system, such as a carbon block filter, a granular activated carbon filter, kdf 55 chlorine removal media, or any other suitable system for removing chlorine. Pre-filters are commercially available, and are used up over time. The life span of pre-filters largely depends on the amount of sediment and other impurities in the source water.

A first pump 20 may pump pre-filtered water from the pre-filtration system 18 through a nano-filtration membrane 22. The first pump may be a rotor vane pump, or any other type of pump suitable for pumping water. The nano-filtration membrane may be purchased commercially in tubular, spiral or flat sheet configurations. An example of a commercially available nano-filtration membrane includes the “FLUID SYSTEMS® TFC®-S, 2.5″ Softening, Tapewrap, Nanofiltration Element.” Another example of a commercially available nano-filtration membrane includes the “FLUID SYSTEMS® TFC®-S, 4.0″ Softening, Tapewrap, Nanofiltration Element.” The nano-filtration membrane is configured to pass monovalent salts, water, acid and alkaline compounds in the nano-filtered water, but to retain organic compounds and divalent salts (such as calcium and magnesium) in the effluent. As much as 90-97% of the divalent salts are retained, where the overall retention by the nano-filtration membrane depends on the concentration of divalent salts in the pre-filtered water provided to the nano-filtration membrane. Removing these divalent salts softens the water, with all of the concurrent benefits associated with soft water. It should, however, be appreciated that a small amount of divalent salts are passed through the nano-filtration membrane. The resulting nano-filtered water therefore retains some hardness. The hardness of nano-filtered water provided by the nano-filtration membranes may be optimized by adjusting the concentration of divalent salts in the pre-filtered water, as discussed below. After filtration, some or all of the effluent may be diverted out of water filtration unit 12 through drain outlet 40.

Nano-filtration is preferable to reverse osmosis and ion exchange for whole building water purification and softening systems. First, nano-filtration membranes remove bacteria, arsenic, silica, or organic compounds, while ion exchange water softeners do not. Second, softening water with nano-filtration membranes does not require dumping large quantities of chloride ions into the drain water, while softening water with ion exchange chemistry does. Third, the small amount of divalent salts passed through the nano-filtration membrane results in nano-filtered water with a sufficient hardness to provide water with better flavor than water softened by ion exchange chemistry or RO membranes. Fourth, in contrast to RO membranes, nano-filtration membranes do not strip the water of its buffering acids and alkaline compounds. While RO filtered water is very acidic and may damage plumbing, nano-filtered water is buffered at a higher pH and is safe for plumbing. Fifth, nano-filtration membranes may have a product to waste water ratio of up to approximately 4:1, as opposed to the up to approximately 1:1 product to waste water ratio of RO membranes.

Water filtration unit 12 may be configured to pressurize the water leaving first pump 20 and entering nano-filtration membrane 22. Nano-filtration membrane 22 operates effectively at water pressures between 50-450 psi. As previously discussed, the water pressure from a municipal water main commonly fluctuates between approximately 40-70 psi. In order to ensure proper water pressure during nano-filtration, water filtration unit 12 may be configured to pressurize the water leaving first pump 20 to a set water pressure between 50-450 psi. Optimally, this water pressure may be set to approximately 120 psi to ensure sufficient, yet not excessive, pressure. Water filtration unit 12 may be configured so that first pump 20 also provides sufficient water pressure to pump nano-filtered water through outlet to tank 24, and into holding tank 26.

It should be appreciated that a plurality of nano-filtration membranes may be used. The plurality of nano-filtration membranes may act in parallel to increase the overall rate at which the water purification system produces nano-filtered water. The plurality of nano-filtration membranes may also act in tandem to concentrate the impurities in the overall effluent, thereby achieving greater purification efficiency. For example, a first nano-filtration membrane may separate pre-filtered water into nano-filtered water and first effluent. The nano-filtered water may be diverted to holding tank 26, while the first effluent may be passed through a second nano-filtration membrane. The second nano-filtration membrane may separate the first effluent into nano-filtered water, which may be diverted to the holding tank, and second effluent, some or all of which may be diverted through drain outlet 40. The second effluent will contain a greater concentration of impurities than the first effluent. Further, by using nano-filtration membranes in tandem, a greater percentage of pre-filtered water is purified into nano-filtered water, and less is wasted as effluent, thereby achieving greater purification efficiency. More or fewer nano-filtration membranes may be desired based on the condition of the source water, the water needs of the building, and the total cost of the water purification system.

Holding tank 26 is operable for receiving and storing nano-filtered water until it is required for use within the building. The holding tank may include inlet from filtration unit 28, reservoir 29, and outlet to filtration unit 30. The holding tank receives nano-filtered water through inlet from filtration unit 28, and stores the water in reservoir 29. Reservoir 29 may be formed of plastic, stainless steel, or any other durable material suitable for storing water. The reservoir should have sufficient volume to store the water needs of the building to which it is attached. Different sized reservoirs may be required for different sized buildings with different water requirements. For example, a 75 gallon reservoir may store an adequate supply of water for a small home, while a 125 gallon reservoir may store an adequate supply of water for a larger home. When water is required by a user within a building, water filtration unit 12 may remove water from the reservoir through outlet to filtration unit 30. Outlet to filtration unit 30 may be configured near the bottom of the reservoir to ensure that all of the water within the reservoir is removable.

As shown in FIG. 2, reservoir 29 may be configured to be compact and stable. The reservoir may be relatively narrow and tall so as to minimize the amount of storage space required. The reservoir may be shaped with a broader base and a narrower top, such as a polyhedron, so as to provide a low center of gravity, particularly when filled with water. A low center of gravity may help to ensure stability, which is especially useful in regions prone to earthquakes, or other unstable conditions. It should be appreciated that the reservoir may be stored above ground, underground or in any place otherwise accessible.

Second pump 34 may pump water from holding tank 26 into the plumbing of a building based on the water needs of the building. When the plumbing of the building is used, thereby creating a need for water, the second pump may draw water from holding tank 26 through inlet from tank 32, and may then pump the water through outlet to the plumbing of the house 36. The second pump may be configured to repressurize the water from holding tank 26 to approximately 40-70 psi, so that there is adequate water pressure within the building.

Water filtration unit 12 may include a post-storage treatment system 36 for sterilizing and removing any airborne bacteria that may have found its way into the water while it was stored in holding tank 26. In FIG. 1, the post-storage treatment system is shown located after second pump 34. It should be appreciated that the post-storage treatment system may be located before or after the second pump. The post-storage treatment system may include an ultraviolet (UV) treatment system, which is used to irradiate the water with a UV light that sterilizes bacteria. Because UV light bulbs have a limited life span, the ultraviolet treatment system may include a detector for determining whether the ultraviolet light bulb needs to be replaced. The post-storage treatment system may include an activated carbon block filter for removing bacteria from the water, and improving the overall taste and smell of the water.

Water filtration unit 12 may include a cleaning solution inlet 42 for passing cleaning solution through nano-filtration membrane 22. The cleaning solution may dissolve salts and organic compounds that have crystallized on the nano-filtration membrane, thereby impeding water flow during purification. For example, the cleaning solution may include a chemical descalar for dissolving and removing scale from the nano-filtration membrane. After the cleaning solution has been passed through the nano-filtration membrane, it may be diverted through drain outlet 40.

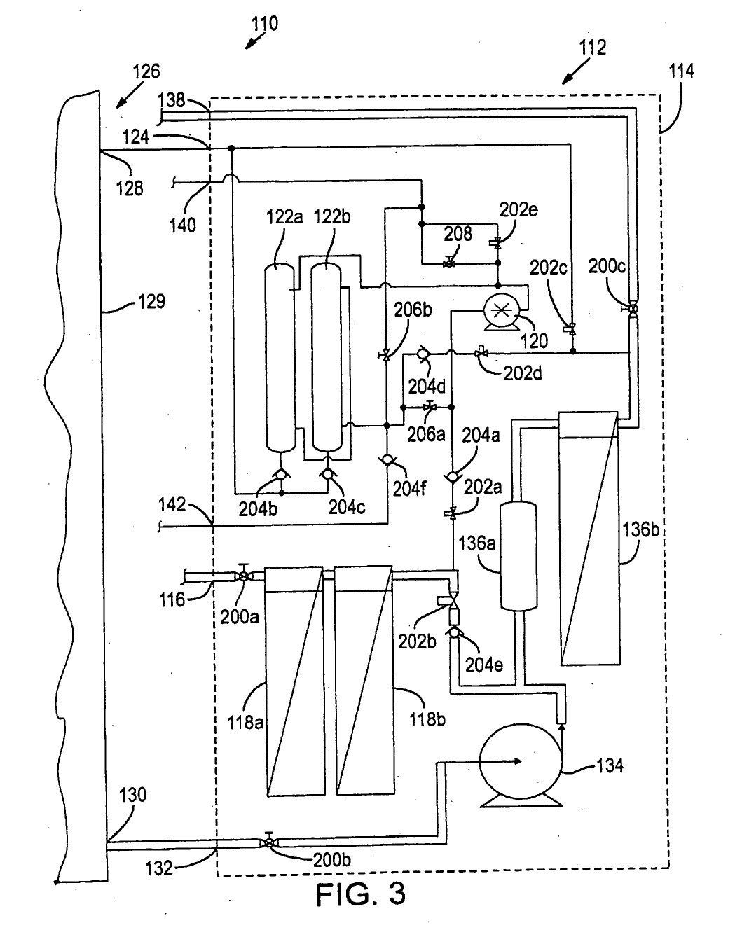

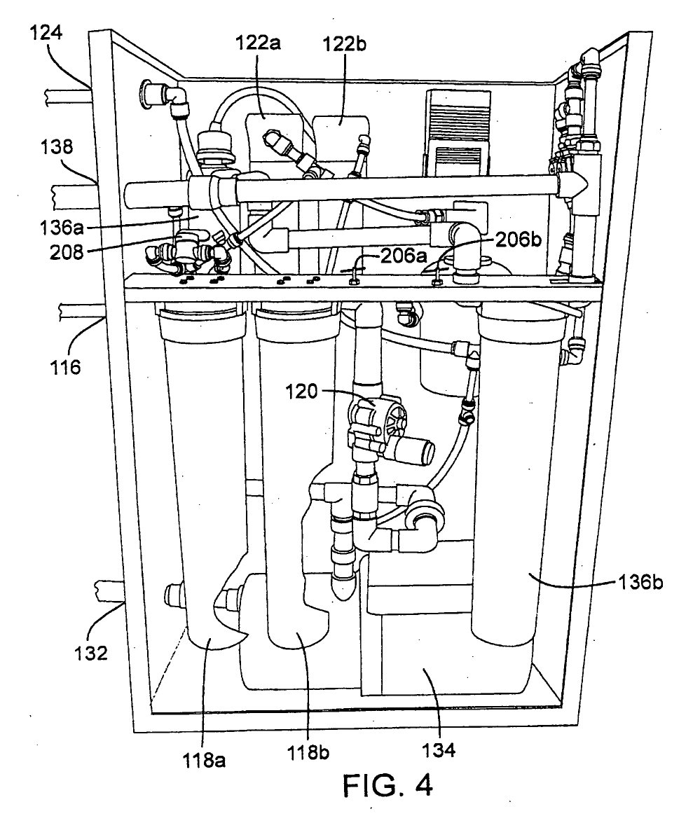

FIG. 3 shows water purification system 110, including a water filtration unit 112 and a holding tank 126. Water filtration unit 112, also shown in FIG. 4, may include housing 114 with a removable panel (not shown) and a removable control unit (not shown). Water filtration unit 112 may also include: inlet from source 116; a pre-filtration system, including sediment filter 118a and carbon filter 118b; first pump 120; nano-filtration membranes 122a and 122b in tandem; outlet to tank 124; inlet from tank 132; second pump 134; a post-storage treatment system, including UV treatment system 136a, and carbon filter 136b; outlet to the plumbing of the building 138; drain outlet 140; and cleaning solution inlet 142. Holding tank 126 may include: inlet from filtration unit 128, reservoir 129, and outlet to filtration unit 130. These components of the purification system function in substantially the same manner as the corresponding components of the embodiment shown in FIGS. 1 and 2. Water filtration unit 112 may also include a plurality of valves, such as ball valves 200a-c, solenoid valves 202a-e, check valves 204a-f, processing valves 206a-b, and cleaning valve 208, which direct the flow of liquid through the purification system.

As shown in FIG. 4, sediment filter 118a, carbon filters 118b and 136b, and UV treatment system 136a may be positioned in accessible locations within the water filtration unit for easy replacement. As discussed with respect to the embodiment shown in FIGS. 1 and 2, sediment filters, carbon filters and UV light bulbs wear out with use. Replacement may be enabled by placing them in an easily accessible location within housing 114, such as immediately behind the removable panel (not shown), or immediately below the removable control unit (not shown).

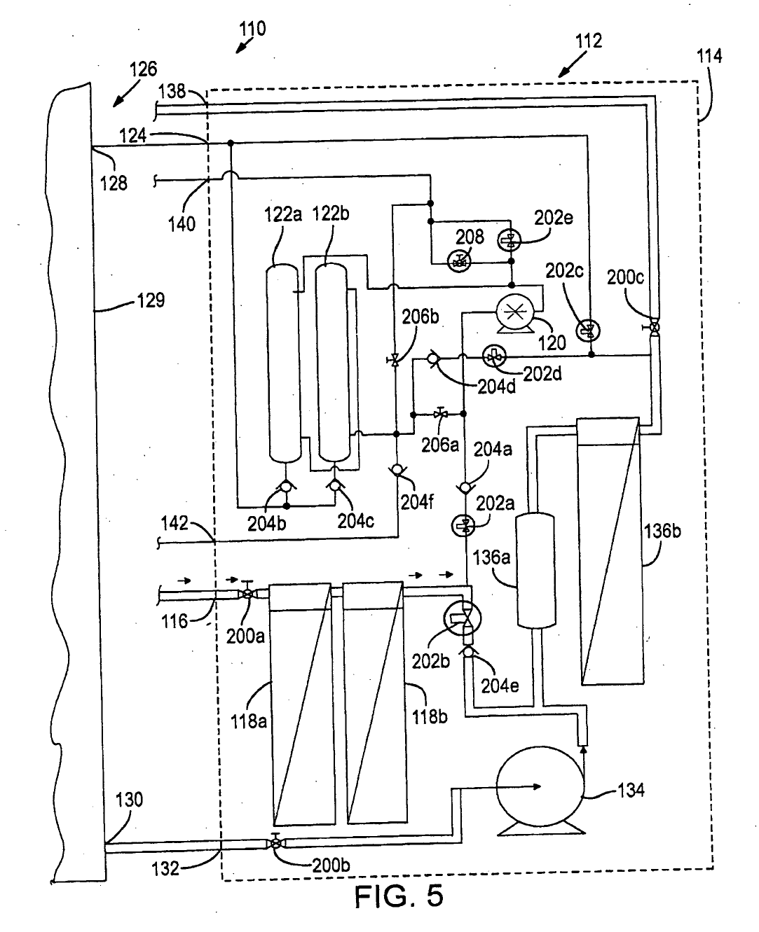

As shown in FIGS. 5-10, the plurality of valves may be actuated to enable the purification system to function in various modes of operation. Some valves may be manually actuated, such as ball valves 200a-c, processing valves 206a-b, and cleaning valve 208. Solenoid valves 202a-e may be automatically actuated by pre-programmed circuitry of the control unit (not shown). Check valves 204a-f are neither manually nor automatically actuated, but rather allow water to pass in one direction but not the other. In FIGS. 5-10, closed valves are shown circled.

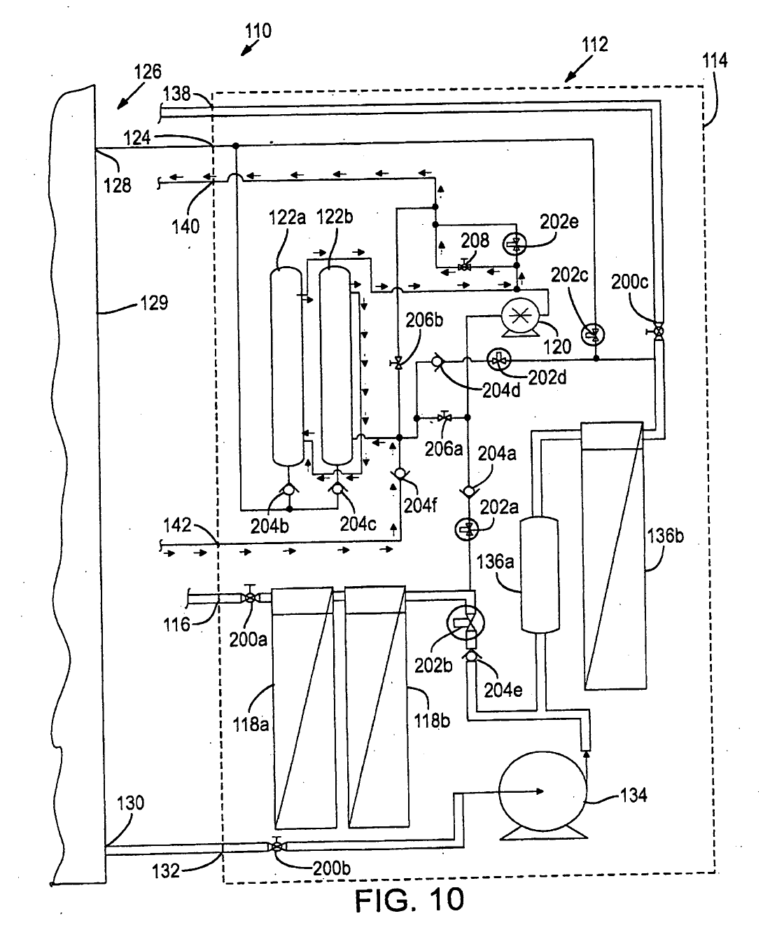

As shown in FIG. 5, some of the manual valves may be actuated immediately after installation, and prior to operation. Prior to operation, the control unit of the purification system is turned off. Because solenoid valves 202a-e are actuated by the control unit, they are therefore closed while the control unit is off. Ball valves 200a-c may be manually opened to allow water to enter water filtration unit 112, and to prepare the water filtration unit for operation. Ball valves 200a-c may remain open during all of the purification system's modes of operation. Processing valves 206a-b may be manually opened, and may remain open during all modes of operation, but may have manually adjustable flow rates, as discussed below. Cleaning valve 208 may be a ball valve that is closed except when it is manually opened for chemical cleaning of the nano-filtration membranes, as discussed with reference to FIG. 10 below.

FIG. 5 shows water purification system 110 in its pre-operation state as well as in its idle mode. After installation, ball valve 200a is opened to allow water to enter water filtration unit 112. As illustrated by the arrows, water enters water filtration unit 112 through inlet from source 116, and flows through ball valve 200a where it is pre-filtered by sediment filter 118a and carbon filter 118b. The pre-filtered water then reaches solenoid valves 202a and 202b, which remain closed until the control unit is turned on.

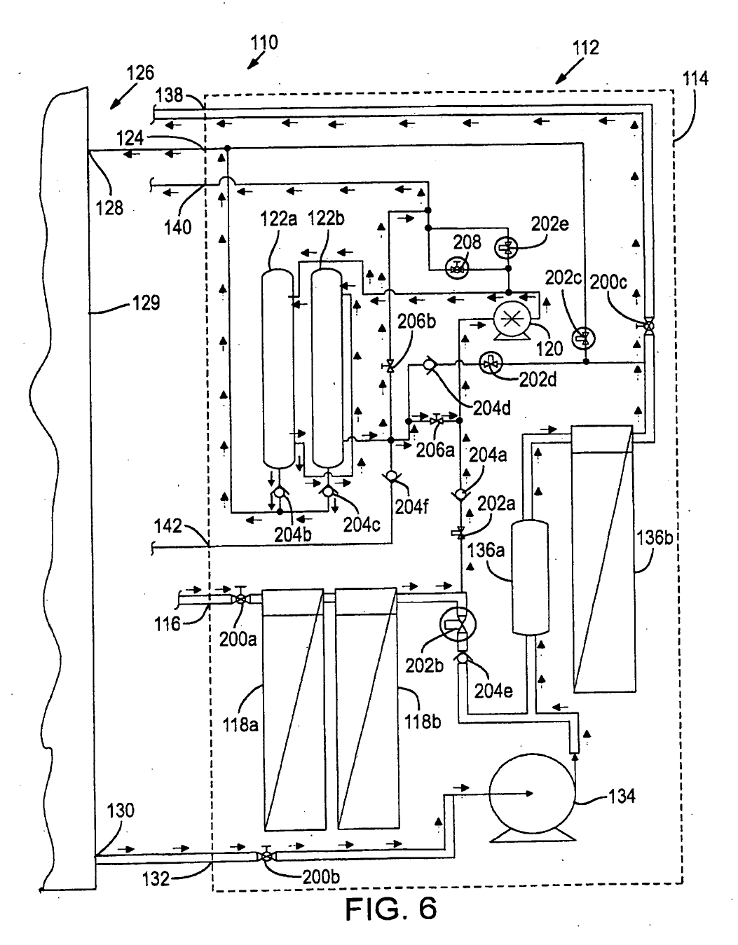

During water purification mode, shown in FIG. 6, the control unit opens solenoid valve 202a, which may also be referred to as purification valve 202a. Solenoid valves 202b-e remain closed. As illustrated by the arrows, water may enter water filtration unit 112 through inlet from source 116, and flow through ball valve 200a where it is pre-filtered by sediment filter 118a and carbon filter 118b. The pre-filtered water may pass through purification valve 202a and check valve 204a where it is pumped by first pump 120 into nano-filtration membrane 122a. Nano-filtered water from nano-filtration membrane 122a may flow through check valve 204b and outlet to tank 124 into holding tank 126 for storage. Effluent from nano-filtration membrane 122a may flow into nano-filtration membrane 122b. Nano-filtered water from nano-filtration membrane 122b may flow through check valve 204c and outlet to tank 124 into holding tank 126 for storage.

As shown in FIG. 6, effluent from nano-filtration membrane 122b may flow into a system for processing the effluent. The effluent processing system may include first processing valve 206a and a second processing valve 206b. As shown by the arrows, the first processing valve may recycle a first portion of the effluent by mixing it with pre-filtered water. The second processing valve may divert a second portion of the effluent to drain outlet 140. The first and second processing valves may be low flow valves with adjustable flow rates, such as needle valves.

Adjusting the flow rate of first processing valve 206a relative to second processing valve 206b may alter the ratio of effluent in the first portion relative to the second portion. For example, increasing the flow rate of first processing valve 206a without adjusting the flow rate of second processing valve 206b may increase the ratio of effluent recycled to effluent diverted to drain outlet 140. As discussed above, small amounts of divalent salts are passed through the nano-filtration membrane. The amount of divalent salts passed is roughly proportional to the concentration of divalent salts in the water entering the nano-filtration membrane. Therefore, increasing the amount of effluent recycled also functions to increase the hardness of nano-filtered water, by increasing the concentration of divalent salts in the water entering the nano-filtration membrane. As another example, decreasing the flow rate of first processing valve 206a without adjusting the flow rate of second processing valve 206b may decrease the ratio of effluent recycled to effluent diverted to drain outlet 140. This decrease in recycled effluent also functions to decrease the hardness of the nano-filtered water, by decreasing the concentration of divalent salts in the water entering the nano-filtration membrane.

Adjusting the first processing valve 206a and second processing valve 206b may regulate the water pressure between first pump 120 and nano-filtration membranes 122a and 122b. For example, tightening both the first and second processing valves without adjusting the pumping force provided by the first pump may increase the water pressure between the first pump and the nano-filtration membranes. Likewise, loosening both the first and second processing valves without adjusting the pumping force provided by first pump may decrease the water pressure between the first pump and the nano-filtration membranes. In this manner, the water pressure between the first pump and the nano-filtration membranes may be manually adjusted to an optimal water pressure, such as 120 psi as discussed above.

As discussed above, second processing valve 206b may divert a second portion of the effluent to drain outlet 140. Drain outlet 140 may be connected to a secondary water system operable for using the effluent. Because the effluent may contain impurities and high concentrations of divalent cations, it is undesirable for human consumption, but may be desirable for other uses, such as irrigation. Further, some U.S. states have regulations regarding the amount of water that must be used by home purification systems, and the amount of water that can be discharged to a drain. In an embodiment, the drain outlet may be connected to an effluent storage tank (not shown) that stores some or all of the effluent for other suitable uses, such as irrigation. The effluent storage tank may be located indoors or outdoors, and may be buried or above ground. The effluent storage tank may also have a flow control valve, such that when it is full, it diverts the effluent to other uses. In an embodiment, the drain outlet may be configured to release some or all of the effluent directly into flower beds, lawns, or gardens. In an embodiment, the drain outlet may be configured to divert all of the effluent to any suitable use that would make water purification system 110 a “zero discharge” system.

As shown in FIG. 6, nano-filtered is stored in holding tank 126 until the plumbing of a building is used, thereby creating a need for water. When this occurs, second pump 134 may draw water through inlet from tank 132 and ball valve 200b. The second pump may then pump the water through UV treatment system 136a, carbon filter 136b, ball valve 200c and outlet to the plumbing of the building 138.

In an embodiment, water purification system 110 may be configured to stop producing water and enter into an idle state if holding tank 126 is filled to capacity. Holding tank 126 may include a meter, guage, detector, float ball, or any other suitable mechanism (not shown) for indicating when a tank is full. When the holding tank is filled to capacity, this mechanism may send a signal to the control unit to enter into an idle state. As shown in FIG. 5, the control unit may then automatically close solenoid valves 202a-e.

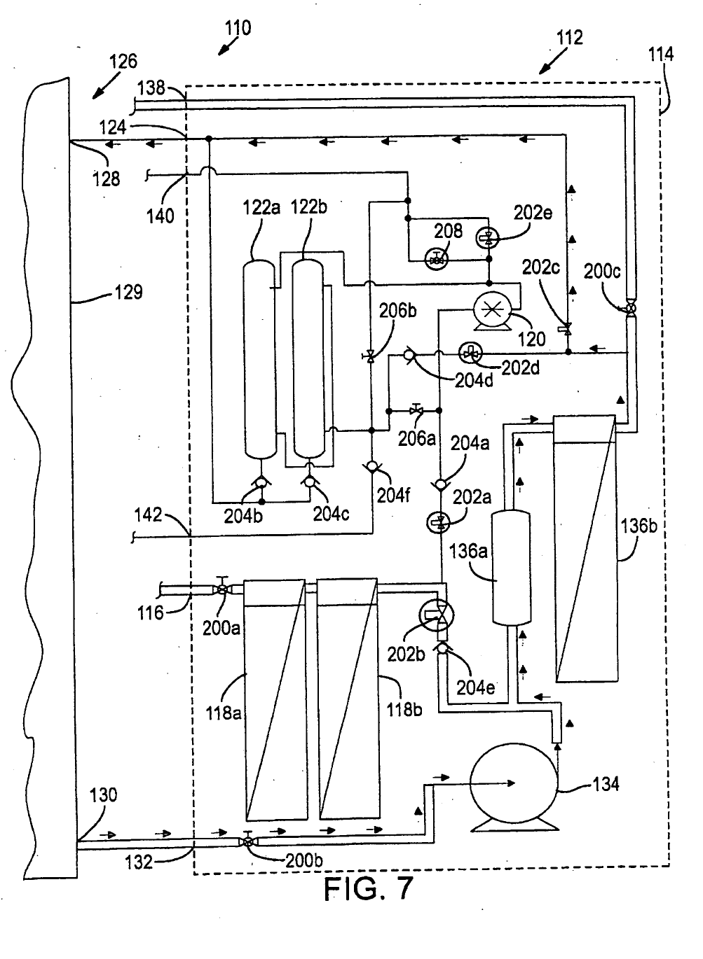

As shown in FIG. 7, water purification system 110 may be configured to periodically recirculate water in holding tank 126 to prevent growth of airborne bacteria that may have found its way into the water. The control unit may be pre-programmed to periodically enter into a recirculation mode. For example, the control unit may enter into recirculation mode once per hour, or any other suitable period. During recirculation mode, the control unit may automatically open solenoid valve 202c, which may also be referred to as the recirculation valve 202c. The control unit also closes solenoid valves 202a-b and 202d-e.

As illustrated by the arrows in FIG. 7, second pump 134 may draw water through inlet from tank 132 and ball valve 200b. The second pump may then pump the water through UV treatment system 136a and carbon filter 136b to sterilize and remove bacteria that may have found its way into the water during storage in the holding tank. It should be appreciated that after passing through carbon filter 136b, if there is no demand for water by a user in the building, no water will flow through ball valve 200c. Rather, water will only flow through recirculation valve 202c and outlet to tank 124 into holding tank 126 for storage.

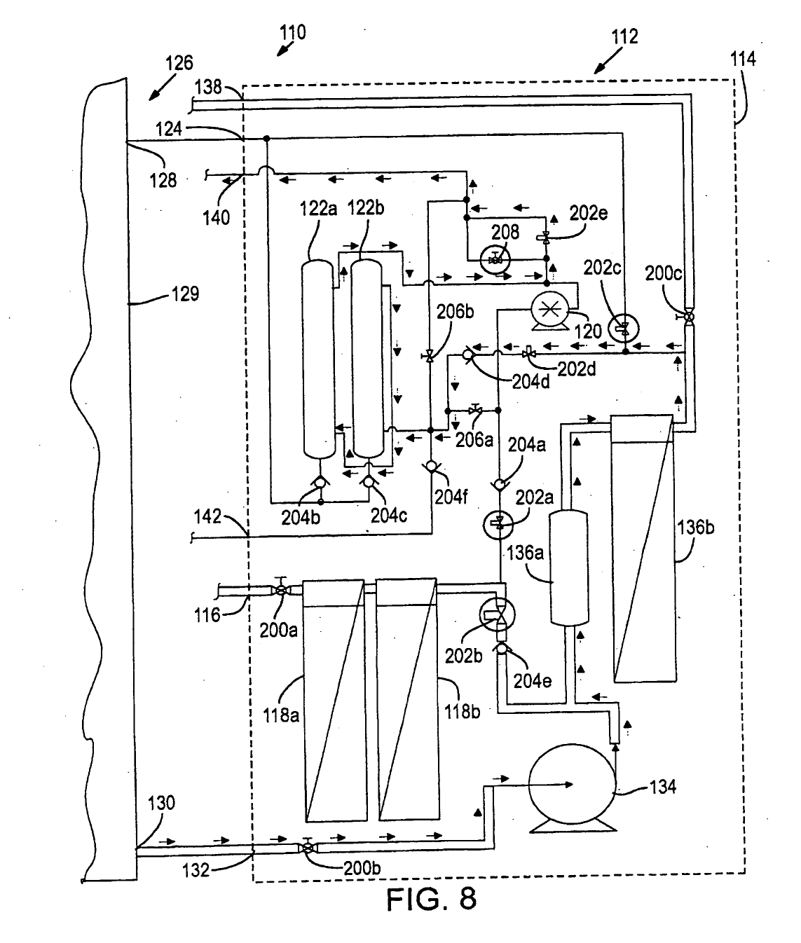

As shown in FIG. 8, water purification system 110 may be configured to periodically backwash nano-filtration membranes 122a and 122b to remove impurities that may affect or impede filtration. The control unit may be pre-programmed to periodically enter into a backwash mode. For example, the control unit may enter into backwash mode once every twelve hours, or any other suitable period. During backwash mode, the control unit may automatically open solenoid valves 202d and 202e, which may also be referred to as backwash valves 202d and 202e. The control unit also closes solenoid valves 202a-c.

As illustrated by the arrows in FIG. 8, second pump 134 may draw water through inlet from tank 132 and ball valve 200b. The second pump may then pump the water through UV treatment system 136a, carbon filter 136b, backwash valve 202d, check valve 204d and backwards through nano-filtration membranes 122b and 122a, respectively. The resulting wash is diverted through backwash valve 202e and drain outlet 140. It should be appreciated that after passing through carbon filter 136b, if there is no demand for water by a user in the building, no water will flow through ball valve 202c. Rather, water will only flow through open solenoid valve 202d. It should also be appreciated that after passing through check valve 204d, some water may flow through processing valve 206a and 206b in addition to flowing backwards through the nano-filtration membranes (not shown). However, because processing valve 206a and 206b are low-flow valves, the majority of the water will follow the path of least resistance and pass backwards through the nano-filtration membranes as shown.

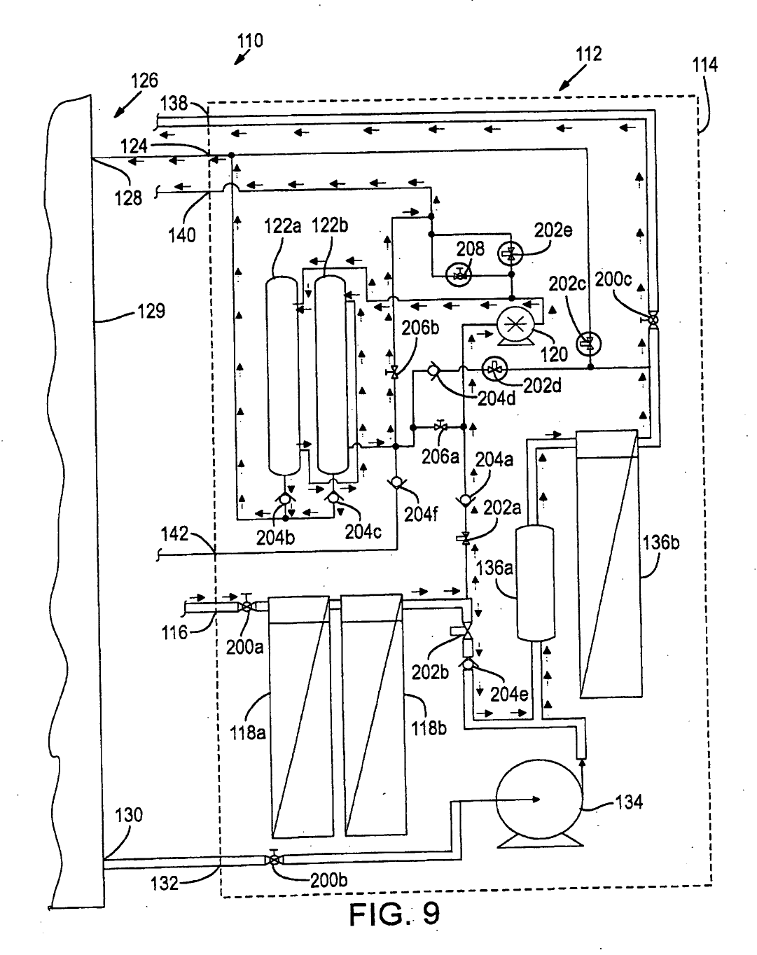

FIG. 9 shows water purification system 110 in bypass mode. Holding tank 126 may become empty, either due to excessive water use within the building, mechanical malfunction within the water filtration unit, severely clogged filters, or any other reason. The purification system may use the bypass mode to provide water to the plumbing of the building if the holding tank is empty. In an embodiment, holding tank 126 may be configured with a meter, gauge, detector, float ball or other suitable mechanism (not shown) for indicating when the holding tank is empty. When the holding tank becomes empty, this mechanism may send a signal to the control unit to enter into bypass mode. The control unit may then automatically open purification valve 202a, and solenoid valve 202b, which may also be referred to as bypass valve 202b.

As illustrated by the arrows in FIG. 9, water may enter water filtration unit 112 through inlet from source 116, and flow through ball valve 200a where it is pre-filtered by sediment filter 118a and carbon filter 118b. The pre-filtered water may pass through both purification valve 202a and bypass valve 202b. The water passing through purification valve 202a may be pumped by pump 120 through nano-filtration membranes 122a and 122b into holding tank 126 as discussed above, unless there is some form of blockage. The water passing through bypass valve 202b may flow through check valve 204e, UV treatment system 136a, carbon filter 136b, ball valve 200c and outlet to the plumbing of the building 138. This may ensure that the building always has a supply of water. Further, when water purification system 110 enters into bypass mode, an audio or visual alarm may be activated to alert users.

FIG. 10 shows water purification system 110 in chemical cleaning mode. Over time, the calcium and magnesium in the pre-filtered water may be deposited on nano-filtration membranes 122a and 122b. These deposits, also called scale, may affect or impede filtration by the nano-filtration membranes. Periodic cleaning with a cleaning solution, such as a bi-annual cleaning with a commercially available chemical descaler, may prevent scale buildup and the consequent loss of function by the nano-filtration membranes. To effectuate cleaning, the power to water purification system 110 should be shut off to prevent any chemical from being pumped into holding tank 126 or into the plumbing of the building. Because solenoid valves 202a-e are actuated by the control unit, they are therefore closed during cleaning while the control unit is off.

As illustrated by the arrows in FIG. 10, cleaning solution may enter water filtration unit 112 through cleaning solution inlet 142. Cleaning solution may be pumped through inlet 142, or may be in a pressurized canister that pushes the cleaning solution through inlet 142. The cleaning solution flows through check valve 204d and backwards through nano-filtration membranes 122b and 122a, respectively. The resulting wash is diverted through cleaning valve 208 and drain outlet 140. It should be appreciated that after passing through check valve 204f, some cleaning solution may flow through processing valve 206a and 206b in addition to flowing backwards through the nano-filtration membranes (not shown). However, because processing valve 206a and 206b are low-flow valves, the majority of the water will follow the path of least resistance and pass backwards through the nano-filtration membranes as shown. After the nano-filtration membranes have been cleaned with cleaning solution, holding tank 126 should be temporarily disconnected from water filtration unit 112, and outlet to tank 124 should be used to divert water to a drain or a waste bucket. Water purification system 110 should then be turned on, and operated in normal operation in order to remove any residual cleaning solution from the system through outlet to tank 124. Several gallons of product water may need to be discarded. After purging the water purification system of residual cleaning solution, the holding tank should be reconnected to the water filtration unit for normal operation.

While the present invention has been particularly shown and described with reference to the foregoing depicted embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

I claim:

1. A water purification system, comprising:
a pre-filtration system for pre-filtering water;
a first pump;
a nano-filtration membrane configured to separate pre-filtered water into nano-filtered water and effluent;
a holding tank; and
a second pump;
wherein the first pump is operable for pumping pre-filtered water through the nano-filtration membrane, and the second pump is operable for pumping nano-filtered water from the holding tank into the plumbing of a building.

2. The water purification system of claim 1, wherein the pre-filtration system includes a sediment filter and a chlorine removal system.

3. The water purification system of claim 1, further comprising an effluent processing system including:
a first processing valve for recycling a first portion of effluent by mixing it with pre-filtered water;
a second processing valve for diverting a second portion of effluent to a drain outlet.

4. The water purification system of claim 3, wherein the first and second processing valves are low flow valves with adjustable flow rates, and wherein adjusting the flow rate of the first and second processing valves alters the ratio of effluent in the first portion relative to the second portion, and regulates the water pressure between the first pump and the nano-filtration membrane.

5. The water purification system of claim 4, wherein the first and second processing valves are needle valves.

6. The water purification system of claim 3, wherein the drain outlet is connected to an effluent storage tank operable for storing effluent for use in irrigation.

7. The water purification system of claim 1, further comprising a post-storage treatment system.

8. The water purification system of claim 7, wherein the post-storage treatment system includes a carbon filter.

9. The water purification system of claim 7, wherein the post-storage treatment system includes an ultraviolet treatment system operable for sterilizing bacteria in the water pumped from the holding tank into the plumbing of the building.

10. The water purification system of claim 7, further comprising a recirculation valve operable for recirculating water from the holding tank, through the post-storage treatment system, and back into the holding tank.

11. The water purification system of claim 10, wherein water is recirculated from the holding tank, through the post-storage treatment system, and back into the holding tank by the pumping action of the second pump.

12. The water purification system of claim 1, further comprising a bypass valve operable for diverting water into the plumbing of the building without passing through the nano-filtration membrane and the holding tank.

13. The water purification system of claim 12, wherein the bypass valve automatically diverts water into the house when the water level in the holding tank is substantially empty of water.

14. The water purification system of claim 1, further comprising a backwash valve operable for diverting water from the holding tank backwards through the nano-filtration membrane.

15. The water purification system of claim 14, wherein the water is diverted from the holding tank backwards through the nano-filtration membrane, by the pumping action of the second pump.

16. The water purification system of claim 1, further comprising a cleaning system including:
an inlet configured to direct a cleaning solution into the nano-filtration membrane; and
a cleaning valve operable for diverting the cleaning solution from the inlet through the nano-filtration membrane, for discharge through a drain outlet.

17. A water filtration unit for connecting to a water main, a holding tank, and the plumbing of a building, comprising:
a pre-filtration system operable for pre-filtering water received from the water main;
a first pump;
a nano-filtration membrane configured to separate pre-filtered water into nano-filtered water and effluent; and
a second pump;
wherein the first pump is operable for pumping pre-filtered water through the nano-filtration membrane, and the second pump is operable for pumping nano-filtered water from the holding tank into the plumbing of a building.

18. The water filtration unit of claim 17, wherein the pre-filtration system includes a sediment filter and a chlorine removal system.

19. The water filtration unit of claim 17, further comprising a post-storage treatment system.

20. The water filtration unit of claim 19, wherein the post-storage treatment system includes a carbon filter.

21. The water filtration unit of claim 19, wherein the post-storage treatment system includes an ultraviolet treatment system operable for sterilizing bacteria in the water pumped from the holding tank into the plumbing of the building.

22. The water filtration unit of claim 17, further comprising a cleaning system including:
an inlet configured to direct a cleaning solution into the nano-filtration membrane; and
a cleaning valve operable for diverting the cleaning solution from the inlet through the nano-filtration membrane, for discharge through a drain line.

23. A holding tank for a water purification system for a building, comprising:
a reservoir operable for storing water, and configured to have a low center of gravity;
an inlet operable for receiving filtered water from a water filtration unit;
an outlet configured substantially near the bottom of the reservoir.

24. The holding tank of claim 23, wherein the reservoir is a polyhedron with a broader base and a narrower top, and is configured to stand substantially upright.

25. The holding tank of claim 24, wherein the reservoir is configured to hold at least 75 gallons of water.

26. The holding tank of claim 24, wherein the reservoir is configured to hold at least 125 gallons of water.

27. A water purification system, comprising:
a holding tank; and
a water filtration unit, including:
a pre-filtration system operable for pre-filtering water;
a first pump;
a nano-filtration membrane configured to separate pre-filtered water into nano-filtered water and effluent; and
a second pump.

28. The water purification system of claim 27, wherein the first pump is operable for pumping pre-filtered water through the nano-filtration membrane, and the second pump is operable for pumping nano-filtered water from the holding tank into the plumbing of a building.

29. A method of purifying water for a building, comprising:
pre-filtering water with a pre-filtration system operable for removing sediment from and dechlorinating water;
separating pre-filtered water into nano-filtered water and effluent with a nano-filtration membrane;
storing the nano-filtered water in a holding tank; and
pumping the nano-filtered water from the holding tank into the plumbing of a building.

30. The method of purifying water of claim 29, wherein pre-filtering water includes diverting municipal water through a sediment filter and a chlorine removal system.

31. The method of purifying water of claim 29, further comprising processing the effluent, including:
recycling a first portion of effluent by diverting it through a first processing valve with an adjustable flow rate, and mixing it with pre-filtered water;
diverting a second portion of effluent through a second processing valve with an adjustable flow rate to a drain line.

32. The method of purifying water of claim 31, further comprising:
increasing the hardness of the nano-filtered water by adjusting the flow rates of the first and second processing valves to increase the ratio of effluent in the first portion relative to the second portion.

33. The method of purifying water of claim 31, further comprising:
decreasing the hardness of the nano-filtered water by adjusting the flow rates of the first and second processing valves to decrease the ratio of effluent in the first portion relative to the second portion.

34. The method of purifying water of claim 31, further comprising:
regulating the water pressure between the first pump and the nano-filtration membrane by adjusting the first and second processing valves.

35. The method of purifying water of claim 34, wherein the water pressure between the first pump and the nano-filtration membrane is regulated to approximately 120 psi.

36. The method of purifying water of claim 29, further comprising:
sterilizing bacteria in the water pumped from the holding tank into the plumbing of the building by irradiating the water with an ultraviolet light.

37. The method of purifying water of claim 29, further comprising:
removing bacteria in the water pumped from the holding tank into the plumbing of the building by filtering the water with a carbon filter.

38. The method of purifying water of claim 29, further comprising:
recirculating water from the holding tank, through a carbon filter, and back into the holding tank.

39. The method of purifying water of claim 29, further comprising:
recirculating water from the holding tank, through an ultraviolet treatment system, and back into the holding tank.
